(19) United States
(12) Patent Application Publication
(10) Pub. No.: US 2011/0100902 A1
(43) Pub. Date: May 5, 2011

(54) MIXING DEVICE, SYSTEM AND METHOD FOR ANAEROBIC DIGESTION

(76) Inventors: Arkady Bluvol, London (CA); Dominic Kisiel, Mt. Brydges (CA); Bill van Logtenstein, Komoka (CA); Michael van Logtenstein, Komoka (CA)

(21) Appl. No.: 12/915,332

(22) Filed: Oct. 29, 2010

Related U.S. Application Data
(60) Provisional application No. 61/255,963, filed on Oct. 29, 2009.

(51) Int. Cl. C02F 3/28; B01D 17/00

(52) U.S. Cl. 210/601; 210/521

(57) ABSTRACT

The present invention relates to a device for digesting organic matter comprising: a vessel having an interior with side walls for containing a material capable of processing the organic matter, and a plate positioned within the interior of the vessel for concentrating the material on a lower section of the vessel, wherein the plate extends from a central axis of the vessel to about the side walls. The present invention also relates to a method of processing organic matter by anaerobic digestion that utilizes the device of the present invention.

### FIELD OF THE INVENTION

The present invention relates to a device, system and method for the digestion of organic matter. Particularly, the present invention relates to a device, system and method for anaerobic digestion of organic matter. Specifically, the present invention relates to a device, system and method for anaerobic digestion of organic matter and maintaining high concentrations of anaerobic bacteria within the device and system to improve the anaerobic digestion process of the organic material.

### BACKGROUND OF THE INVENTION

Anaerobic digestion is a traditional method of treating organic matter found in materials and/or fluids, such as wastewater. Anaerobic digestion converts the organic matter into biogas (methane). As such, anaerobic digestion is very suitable for the treatment of wastewater containing large amounts of organic waste generated by agricultural production (animal farms).

Anaerobic digesters are devices utilized for the anaerobic treatment of materials and/or fluids containing organic solids, such as wastewater and/or animal manure and, possibly, for recovering biogas for energy production.

Continuous digesters are a type of anaerobic digesters in which the materials and/or fluids to be treated are constantly or regularly directed into a column that is rich in anaerobic bacteria. The material moves through the anaerobic digester either mechanically or by the force of the new feed pushing out digested material.

Common problems with continuous digesters include plugging of the digester and keeping a high concentration of anaerobic bacteria within the anaerobic digester for a more effective treatment of the materials and/or fluids containing organic solids.

U.S. Pat. No. 6,911,149 discloses an Induced Blanket Reactor (IBR), which is a type of continuous vertical anaerobic digester. U.S. Pat. No. 6,911,149 employs a septum attached to the side walls of the vessel, an aperture located on the center of the septum, and an auger traversing the aperture to retain anaerobic bacteria below the septum and to address the plugging problem. However, the space between the auger and the central aperture is the only communication between the lower and upper portions of the vessel. A major drawback of the apparatus disclosed in this patent is that in practice the bioreactor often plugs between the auger and the central aperture.

There is a need, therefore, to provide a bioreactor that quickly forms high concentration of bacteria, separating settling solids from the liquid in which settling solids are suspended and does not have plugging problems associated with high concentration of solids.

### SUMMARY OF THE INVENTION

The present invention relates to a device, system and method for digesting organic matter capable of keeping high concentration of bacteria within the device and prevent the plugging problems that are common in the anaerobic reactors of the prior art.

As such, in one aspect, the present invention provides for a device for processing organic matter comprising a vessel having an interior with side walls, said interior suitable for containing a material capable of processing the organic matter, and a plate positioned within the interior of the vessel for concentrating the material on a lower section of the vessel, wherein the plate extends from a central axis of the vessel to about the side walls of the vessel thereby creating a space between the side walls and a periphery of the plate.

In another aspect, the plate positioned within the interior of the vessel can rotate about the central axis of the vessel.

In another aspect, the device for processing organic matter of the present invention further comprises means for rotating the plate about the central axis of the vessel.

In another aspect, the device of the present invention further comprises a shaft operatively coupled to the rotating means, and one or more mixing means attached to the shaft.

In another aspect of the invention, the device further comprises an inlet coupled to the vessel for introducing the organic matter into the vessel, and an outlet coupled to the vessel for directing the treated matter to the outside of the vessel.

In another aspect of the invention, the device comprises one or more plates positioned within the interior of the vessel, wherein the one or more plates extend from a central axis of the vessel to about the side walls of the vessel.

In another aspect of the invention the device is an anaerobic digester.

In another aspect of the invention the organic matter is wastewater.

In yet another aspect, the present invention provides for a system for processing organic matter comprising: a source of activated sludge for promoting anaerobic digestion of the organic matter, a source of organic matter for circulating the organic matter through the system, at least one device for anaerobically processing the organic matter circulating through the system, wherein said device comprises a vessel for containing the source of activated sludge, a plate positioned within the interior of the vessel, wherein the plate extends from the central axis of the vessel to about side walls of the vessel thereby creating a space between the side walls and a periphery of the plate, and a discharge system for removing by-products off the system.

In a further aspect, the present invention provides for a method of processing organic matter by anaerobic digestion, comprising: (a) providing at least one device, wherein said device comprises a vessel for containing the source of activated sludge, a plate positioned within the interior of the vessel, wherein the plate extends from the central axis of the vessel to about side walls of the vessel thereby creating a space between the side walls and a periphery of the plate, (b) charging the vessel with an activated sludge material for promoting anaerobic digestion of the organic matter; (c) introducing the organic matter into the vessel, and (d) removing by-products off the vessel.

Advantages of the device of the present invention include:

(a) significantly preventing bacteria from exiting the vessel with effluent;
(b) higher concentration of bacteria within the vessel results in more efficient digestion process;
(c) no plugging problems as the plate within the vessel is not attached to the side walls of the vessel and can rotate;
(d) keeping uniform temperature of the sludge bed and preventing crust from forming on the plate.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a front view of the bioreactor according to the present invention, including a broken away portion showing the interior of the bioreactor.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The invention will be explained in details by referring to the one or more figures herein presented.

The present invention relates to a device for processing or digesting organic matter. In aspects, the present invention relates to a device for anaerobically processing organic matter.

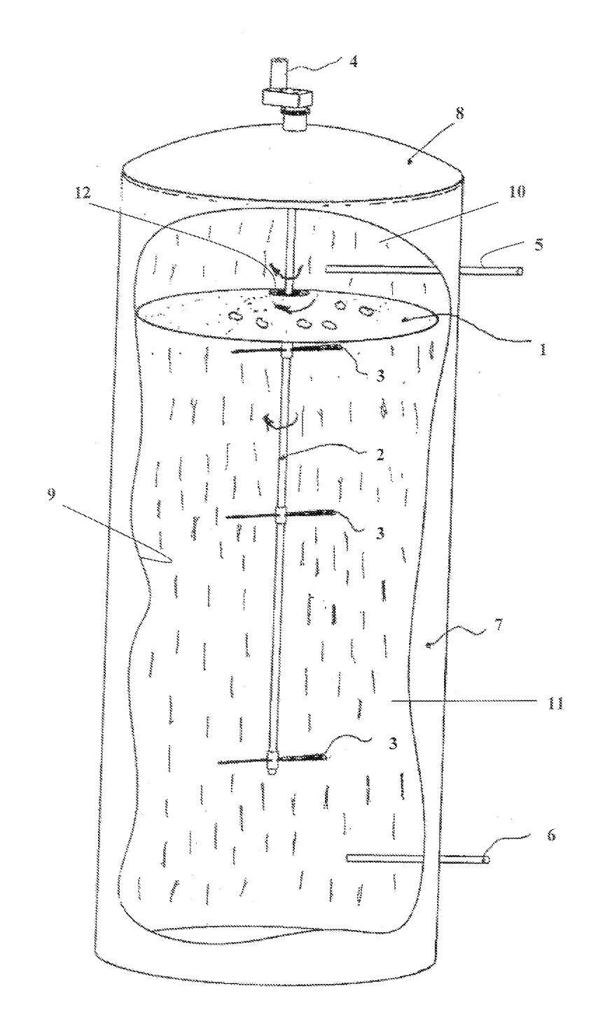

Referring to FIG. 1, the device 8, which in aspects of the invention comprises an anaerobic reactor, comprises a vessel 7 having an interior with side walls 9 suitable for containing a sludge bed. The vessel 7 is shown in FIG. 1 as cylindrical, however other vessel shapes can be used without departing from the scope of the present invention.

The device 8 also comprises a plate 1 positioned within the vessel 7. The plate 1 extends from a central axis of the vessel 7 to about the side walls 9 of the vessel 7. That is, the diameter of the plate 1 is smaller than the inner diameter of the vessel 7. The plate 1 divides the chamber of the vessel 7 into an upper section 10 and a lower section 11. Since the plate 7 extends to about the side walls 9, the upper and lower sections 10, 11 are in fluid communication through the space formed between the plate 1 and the sidewalls 9. In one aspect of the present invention, the plate 1 includes a central aperture or opening 12. In this aspect of the invention, the upper and lower sections 10, 11 of the vessel 7 are also in fluid communication through the central aperture 12. Plate 1 can also include a plurality of apertures that communicate the lower and upper sections 10, 11 of the vessel 7.

Plate 1 can be flexible or rigid and can be made out of steel, plastic or the like. Plate 1 can consist out of the single formed piece of material or comprised out of plurality of panels joined together. In one aspect of the present invention, the deflector plate 1 slopes up from the central axis of the vessel. In another aspect of the invention, the plate 1 slopes down from the axis of the vessel 7.

The plate 1 is operably connected to a mixing means for rotating the plate 1 about its central axis. In one aspect of the invention, the mixing means include a mixer 4 and a shaft 2. The plate 1 can be connected to the shaft of the mixer. A series of paddles or mixer blades 3 can be mounted on the shaft 2 for rotation.

Deflector plate 1 can be positioned at various heights on the shaft above the mixer blades 3.

Rotating the plate 1 within the vessel 7 helps separate solids with attached bacteria and gas bubbles to keep the bacteria within the lower section of the vessel 7.

Wastewater containing high concentrations of organic matter can be introduced for treatment into the vessel 7, for example through the inlet pipe 6. The device 8 of the present invention is particularly applicable to anaerobically treat wastewater generated through agricultural production and food processing. The anaerobically-processed wastewater can leave the vessel 7 through an effluent pipe 5. The plate 1 divides the anaerobic reactor 8 into an upper section and a lower section. The influent pipe and the blades 3 can be located within the lower section of the vessel 7. The effluent pipe 5 can be located on the upper section of the vessel 7.

In operation, the organic matter to be treated enters the device 8 through, for example, to the influent pipe 6. The activated sludge for promoting anaerobic digestion of the organic matter is concentrated on the lower section of the vessel 7. Solids within the activated sludge are maintained on the lower section 10 of the vessel 7 by the plate 1. As the bacteria process the organic matter, biogas is generated. Gas bubbles separate from bacteria and solid particles and rise to the top of the vessel 7. Plate 1 allows biogas to rise up through the space between inner side walls 9 of the vessel 7 and the periphery of the plate 1, or through the one or more openings on the plate 7.

When the shaft 2 is rotated in one direction, the solids and the fluid are forced down reaching the bottom of the vessel 7 where they get deflected to the upward flow.

Solids with attached bacteria and attached gas bubbles move upward reaching the deflector plate 1. When contacting the deflector plate 1 bacteria gets knocked off by deflector plate 1 and falls down remaining in the vessel 7. Therefore more bacteria is retained in the lower section of the vessel 7 and are available to break down the organic matter at a much faster rate.

By utilizing the bacteria control mechanism described herein, wastewater can be treated much faster and more efficiently reducing the capital cost and operational cost.

The above disclosure generally describes the present invention. Changes in form and substitution of equivalents are contemplated as circumstances may suggest or render expedient. Although specific terms have been employed herein, such terms are intended in a descriptive sense and not for purposes of limitation. Other variations and modifications of the invention are possible. As such modifications or variations are believed to be within the sphere and scope of the invention as defined by the claims appended hereto.

We claim:

1. A device for processing organic matter comprising:
(a) a vessel having an interior with side walls, said interior suitable for containing a material capable of processing the organic matter, and
(b) a plate positioned within the interior of the vessel for concentrating the material on a lower section of the vessel,
wherein the plate extends from a central axis of the vessel to about the side walls of the vessel thereby creating a space between the side walls and a to periphery of the plate.

2. The device of claim 1 wherein said plate can rotate about the central axis of the vessel.

3. The device of claim 1 further comprising means for rotating the plate about the central axis of the vessel.

4. The device of claim 2 further comprising:
(a) a shaft operatively coupled to the plate, and
(b) one or more mixing means attached to the shaft.

5. The device as in either claim 1 or 2 further comprising:
(a) an inlet coupled to the vessel for introducing the organic matter into the vessel, and
(b) an outlet coupled to the vessel for directing the treated organic matter off the vessel.

6. The device of claim 1 wherein said device comprises one or more plates positioned within the interior of the vessel, wherein the one or more plate extend from a central axis of the vessel to about the side walls of the vessel thereby creating a space between the side walls and a periphery of the plates.

7. The device of claim 1 wherein said processing is anaerobic digestion.

8. The device of claim 1 wherein the organic matter is wastewater.

9. A system for processing organic matter comprising: a source of activated sludge for promoting anaerobic digestion of the organic matter, a source of organic matter for circulating the organic matter through the system, at least one device to as claimed in claim 1 for anaerobically processing the organic matter circulating through the system, and a discharge system for removing by-products off the system.

10. A method of processing organic matter by anaerobic digestion, comprising:
(a) providing at least one device as claimed in claim 1,
(b) charging the vessel with an activated sludge material for promoting anaerobic digestion of the organic matter;
(c) introducing the organic matter into the vessel, and
(d) removing by-products off the vessel.
